(19) United States
(12) Patent Application Publication
(10) Pub. No.: US 2015/0248506 A1
(43) Pub. Date: Sep. 3, 2015

(54) MULTIPLE PROGRAMMABLE LOGIC CONTROLLER SIMULATOR

(71) Applicant: Thomas Brian Hartley, Johnson City, TN (US)

(72) Inventor: Thomas Brian Hartley, Johnson City, TN (US)

(21) Appl. No.: 14/428,157

(22) PCT Filed: Sep. 18, 2012
(86) PCT No.: PCT/US2012/055877

§ 371 Date: Mar. 13, 2015

(51) Int. Cl. G06F 17/50

(52) U.S. Cl. CPC G06F 17/5009

(57) ABSTRACT

The disclosed embodiments relate to simulation of multiple PLCs which are to be physically implemented in a networked or otherwise coordinated manner, such as to control various industrial machines and/or implement multiple steps used in performing an industrial process. Each simulated PLC 114 is throttled relative to each of the other simulated PLCs 114 by use of a common simulated clock 116. The physical characteristics of the particular PLC being simulated are used to ensure that each PLC's behavior is consistent with the physical characteristics of the other PLCs being simulated, e.g. relative to the time elapsed by the common simulated clock 116. Accordingly, simulation of a PLC having physical characteristics different from one or more of the other PLCs will reflect the differences and provide a more accurate representation of the expected actual operation thereof.

### BACKGROUND

A programmable logic controller (“PLC”), or programmable controller, is a digital computer used for automation of electromechanical processes, such as control of machinery on factory assembly lines, amusement rides, or light fixtures. PLCs are used in many industries and machines. Unlike general-purpose computers, the PLC is designed for multiple input and output arrangements, extended temperature ranges, immunity to electrical noise, and resistance to vibration and impact. Programs to control machine operation are typically stored in battery-backed-up or non-volatile memory. A PLC is an example of a hard real time system since output results must be produced in response to input conditions within a limited time, otherwise unintended operation will result.

The main difference from other computers is that PLCs are typically armored for severe conditions (such as dust, moisture, heat, cold) and have the facility for extensive input/output (I/O) arrangements to connect, for example, to sensors and actuators. PLCs may be capable of reading limit switches, analog process variables (such as temperature and pressure), and the positions of complex positioning systems. Some PLCs may use machine vision and/or may operate electric motors, pneumatic or hydraulic cylinders, magnetic relays, solenoids, or analog outputs. The input/output arrangements may be built into a simple PLC, or the PLC may have external I/O modules, which may be referred to as “signal modules,” attached to a computer network that plugs into the PLC.

Modular PLCs may include a chassis (also called a rack) into which are placed modules with different functions. The processor and selection of I/O modules are customized for the particular application. Several racks may be administered by a single processor, and may have thousands of inputs and outputs. A communications medium, such as a special high speed serial I/O link, may be used so that racks can be distributed away from the processor, reducing the wiring costs for large plants.

Multiple PLCs may be used in environments, such as manufacturing environments, to control and coordinate multiple various machines involved in a particular process. This may require that the operations of the PLCs, which result in, or otherwise direct, the performance of the various operations by the manufacturing equipment, be coordinated or otherwise synchronized so that the appropriate steps of manufacturing processes are performed in the appropriate coordinate, temporal and/or sequential manner.

### BRIEF DESCRIPTION OF THE DRAWINGS

FIG. 1 depicts a block diagram of a system for simulating operation of a plurality of programmable logic controllers.

FIG. 2 shows a flow chart depicting operation of the system of FIG. 1 according to one embodiment.

FIG. 3 shows a flow chart depicting operation of the system of FIG. 1 according to another embodiment.

FIG. 4 shows a block diagram of a general computer system for use with the disclosed embodiments.

### DETAILED DESCRIPTION

The disclosed embodiments relate to simulation of multiple PLCs which are to be physically implemented in a networked or otherwise coordinated manner, such as to control various industrial machines and/or implement multiple steps used in performing an industrial process. Each simulated PLC is throttled relative to each of the other simulated PLCs, in one embodiment, by use of a common simulated clock. The physical characteristics of the particular PLC being simulated are used to ensure that each PLC behaves in a manner consistent with the physical characteristics of the other PLCs being simulated, e.g. relative to the time elapsed by the common simulated clock. Accordingly, using the disclosed embodiments, simulation of a PLC having physical characteristics different from one or more of the other PLCs will reflect the differences and provide a more accurate representation of the expected actual operation thereof. For example, simulation of slower PLCs will exhibit behaviors that are slower relative to the behaviors of the simulations of faster PLCs.

Accurate simulation of networks can help in creating better cost analysis and planning. When bidding on a job, it is often difficult to know what equipment is required due to unforeseen bottlenecks. It is also difficult to identify wasted resources. It is desirable that the implementation designer determine the necessary level of performance to achieve the desired functionality while minimizing unnecessary costs.

In addition, as was noted above, when utilizing multiple PLCs to control different portions of a manufacturing or other industrial process, it may be necessary to coordinate the operations of the PLCs to effect the desired coordinated implementation thereof. For example, on a manufacturing line which applies labels to containers, one would want to ensure that the machine which applies the label to the container is coordinated with the machine which feeds the containers thereto so that a container is positioned properly when the label is applied. As different PLCs may have different performance characteristics, such as processor clock speed, instruction throughput, memory bandwidth, or other physical characteristics, etc. which may affect their performance, it may be necessary to adjust, tune or otherwise modify the operation of one or more of the PLCs used to perform the process in order to ensure that their operations are suitably coordinated and/or synchronized with the other PLCs. That is, some PLCs may execute their control programs, or portions thereof, faster than other PLCs. Anticipation/prediction of the need for such adjustments prior to implementation or when modifying an implementation may be difficult. Further, performance of these adjustments in a live manufacturing environment may be time consuming and inefficient and may result in wasted resources and lost revenue as the PLCs are appropriately adjusted and then tested to ensure satisfactory operation. In mission critical applications, the ability to test and tune may be severely limited.

Accordingly, simulation of the operation of the PLCs may be appropriate whereby computer models of the PLCs are created and operated in a computer simulated environment in order to demonstrate the expected operation and identify any problems. This may then allow any necessary adjustments to the actual implementation to be anticipated and accounted for prior to or during implementation, thereby reducing inefficiencies. For example, a faster PLC may have its performance reduced to properly synchronize with a slower PLC or a different PLC may be determined to be better suited for the overall implementation. Unfortunately, existing simulation systems do not model the actual relative performance differences between different types of PLCs having different performance characteristics making it difficult to anticipate and implement the necessary operational adjustments. That is, when a fast controller is simulated on a network, that controller will not appear to be faster than a slower controller on the same simulated network, thereby, for example, masking the potential need to adjust the operation of one or both PLCs to coordinate their actual operation.

The disclosed embodiments relate to a simulation engine or simulator which may simulate the operation of multiple PLCs whereby the relative performance capabilities of each PLC are accounted for. Generally, in the disclosed embodiments, the simulated PLCs throttle themselves relative to each other. For example, if an implementation includes two PLCs, a PLC ‘x’ that is twice as fast as a PLC ‘y’. On a physical network PLC ‘x’ will perform twice as many of the same instructions as PLC ‘y’. These performance characteristics are well known attributes of each physical PLC (i.e. the execution times for instructions for a given PLC are known). In one embodiment, during simulation, a time token is passed to each simulated PLC. Each PLC will inspect the time token to determine its appropriate behavior. If the time token indicates that enough time has lapsed relative to the other PLCs on the network, the PLC will execute its queued instructions. If enough time has not lapsed relative to the other PLCs on the network, the token is passed to the next simulated controller. The determination of whether a PLC should execute an instruction may be done by the simulated PLC keeping track of the base time it completed execution of an instruction and adding the time that its queued instruction (instruction characteristics are known for the simulated PLC) requires. If the base time plus the queued instructions time is less than the current token's time, the instruction is executed. This will be done until there are no more instructions that can be executed within the time indicated by the time token. One additional instruction will be executed and the time token adjusted appropriately (i.e. the new time token will be incremented by any additional time required to execute this final instruction). The PLC will note the completion time of this last instruction executed and the token passed to the next simulated PLC. The time token will continue to be passed from PLC to PLC until the simulation ends. This technique will throttle each PLC so that they progress in lock-step relative to each other, more accurately simulating a physical network.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

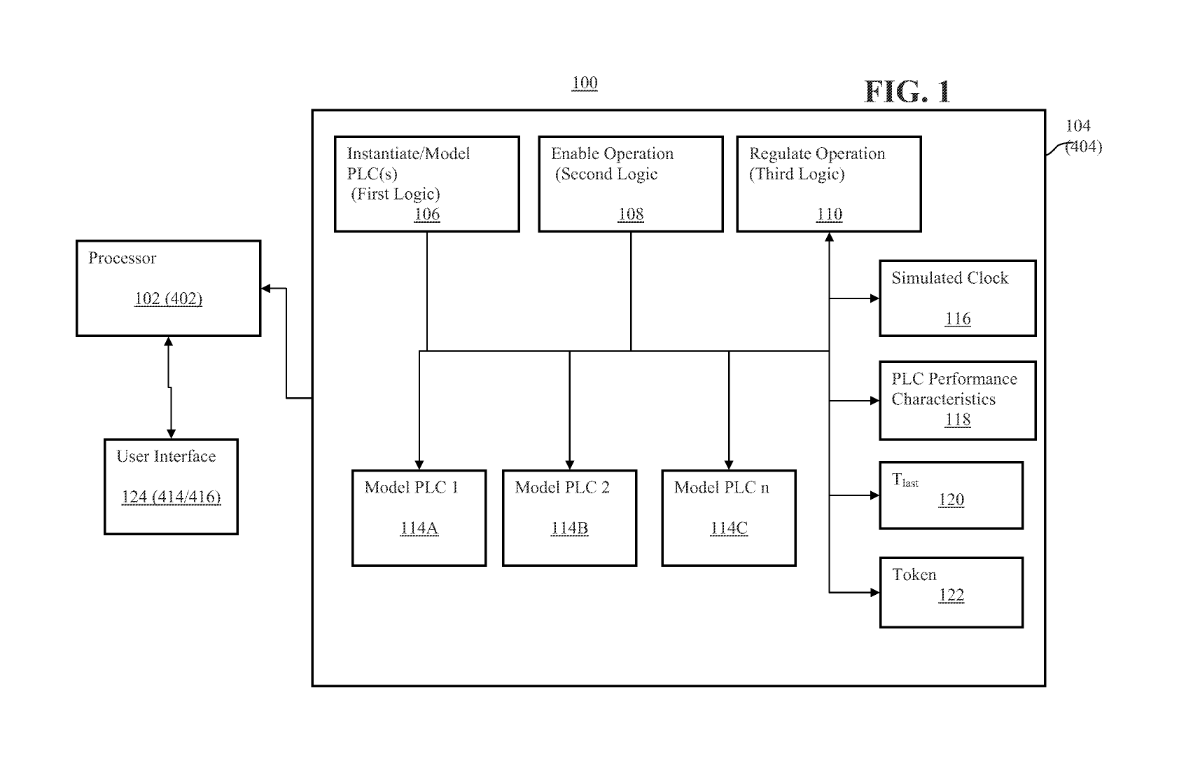

FIG. 1 shows a block diagram of a system 100 for simulating operation of a plurality of programmable logic controllers (“PLC”), each of the plurality of PLCs being characterized by at least one performance characteristic 118 according to the disclosed embodiments. The performance characteristics 118 may vary among the PLCs and may include processor speed, instruction throughput, response time or other attribute defining the performance of the particular PLC. Generally, the performance characteristics 118 characterize the instruction execution performance of the PLC and may, for example, define the amount of time, e.g. in cycles or other measure of time, particular PLC control program instructions or types of instructions require to execute. The performance characteristics 118 may be implemented as data values stored in the memory 104 as described above or may be integrated with the simulation models of the PLCs.

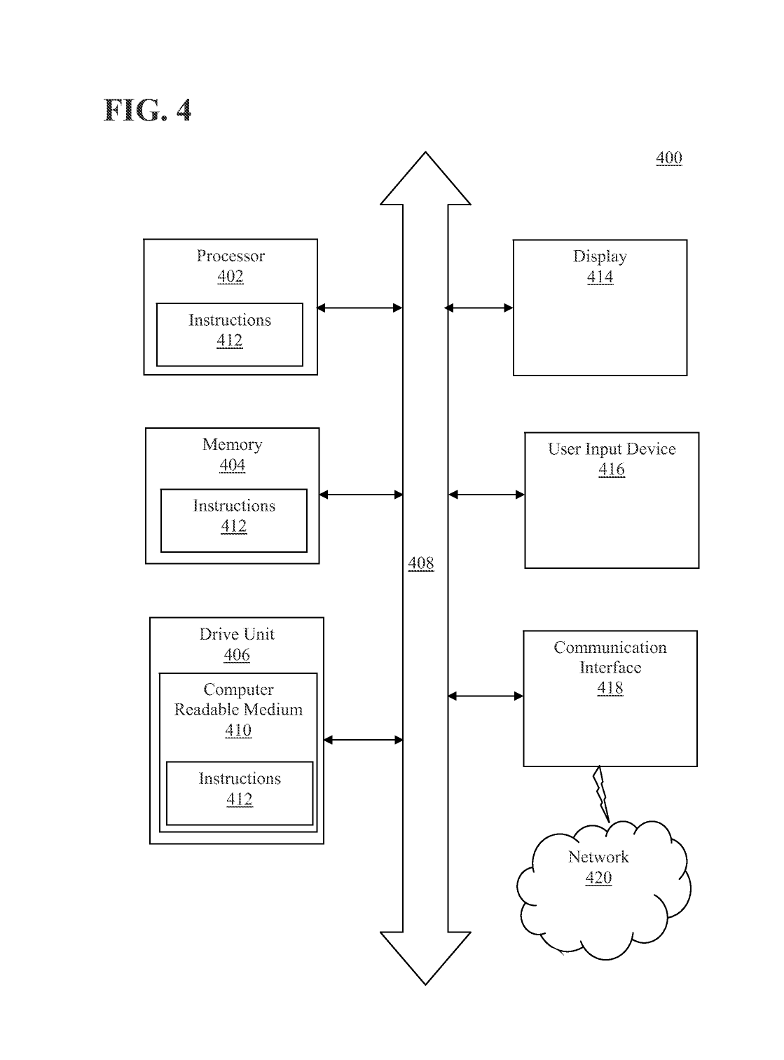

It will be appreciated that the simulation system 100 may be implemented in one or more computing devices, such as the computing device 400 described below with respect to FIG. 4. While exemplary embodiments will be describe herein with respect to a single processor 102 coupled with a single memory 104, which may be implemented using the processor 402 and memory 404 described below with respect to FIG. 4, it will be appreciated that the disclosed embodiments may be implemented in a loosely or tightly coupled multiprocessor and or multi-memory system. Further, while the disclosed simulation control logic is described as being stored in the same memory in which the modeled PLCs are instantiated, it will be appreciated that the modeled PLCs may be instantiated in a separate memory or in a separate computer system controlled by a separate processor. For example, dedicated simulation computer systems may be provided for executing the PLC simulation models under the control a separate control system.

Referring back to FIG. 1, in the exemplary embodiment, the system 100 includes first logic 106 stored in a memory 104 and executable by a processor 102 to cause the processor 102 to instantiate or otherwise model operation of each of the plurality of PLCs. As described, the simulated PLCs may be instantiated in the same or a different memory as the first logic 106. The system 100 may further include a user interface 124, such as the user interface 414/416 described below with respect to FIG. 4, for receiving instructions or commands from a user, such as commands to instantiate PLC models 114, initiate a simulation as described herein, or provide data such as PLC performance characteristics, and provide output to the user, such as results of the simulation.

The system 100 further includes second logic 108 stored in the memory 104 and executable by the processor 102 to cause the processor 102 to enable each PLC model 114 to simulate operation of the associated modeled PLC, the remaining PLC models 114 not being enabled to simulate operation of the associated modeled PLC. As will be described, each modeled PLC 114 is enabled one at a time to execute instructions as will be described further.

The system 100 further includes third logic 110 stored in the memory 104 and executable by the processor 102 to cause the processor 102 to regulate initiation of instruction execution by the enabled PLC model 114, based on the at least one performance characteristic 118 of the PLC modeled thereby, relative to an instruction execution performance of one or more of the previously enabled PLC models 114. The at least one performance characteristic 118 for each PLC model 114 may be stored in the memory 104 separately or otherwise in conjunction with or as part of each PLC model 114. In one embodiment, the instruction execution performance of one or more of the previously enabled PLC models 114 comprises a longest cumulative execution time of any of the one or more previously enabled PLC models 114 needed to complete execution of instructions initiated when the particular of the one or more previously enabled PLC models 114 was previously enabled.

In one embodiment, the third logic 110 may be further executable by the processor 102 to cause the processor 102 to define the instruction execution performance for the next PLC model 114 to be enabled based on completion of execution of the instruction for which execution was initiated by the enabled PLC model 114.

In one embodiment, the third logic 110 may be further executable by the processor 102 to cause the processor 102 to advance a simulated clock 116 value, which may be stored in the memory 104 or elsewhere, based on a cumulative time to complete execution of the instructions initiated by the enabled PLC model 114, the instruction execution performance for the next enabled PLC model 114 being defined thereby.

In one embodiment, the third logic 110 may be further executable by the processor 102 to cause the processor 102 to determine if sufficient time is available to initiate execution of a next instruction of a plurality of instructions since the enabled PLC model 114 last executed an instruction 120 and, if sufficient time is available, allow the enabled PLC model 114 to at least initiate execution of the next instruction, repeat the determining until sufficient time is not available to initiate execution of a next instruction of a remainder of the plurality of instructions, and, wherein when sufficient time is not available, disable the enabled PLC model 114 to simulate operation and enabling another of the plurality of PLC models 114 to simulate operation. In one embodiment, the third logic 106 may be further executable by the processor 102 to cause the processor 102 to allocate or otherwise provide a token 122 or other signal, flag or data, to one of the plurality of PLC models 114, the token 122 being operative to enable the one PLC model 114 to execute instructions. Wherein those PLC models 114 which are not allocated the token 122 are inhibited from executing instructions. To enable each PLC model in turn, the token 122 may be passed or otherwise reallocated to each PLC in turn. The token 122 may be a data packet which carries additional data, such as the current simulation time, from PLC model 114 to PLC model 114. Alternatively, the token 122 may be implemented as a register or memory location in the memory 104 or elsewhere which stores data representative of the currently enabled PLC model 114 to which the third logic 106 and/or each PLC model 114 refers to determine which PLC model 114 is presently enabled.

The third logic 110 may be further executable by the processor 102 to cause the processor 102 to determine a current time, such as from the token 122 described above, simulated clock 116 or, for example, a central time server, and a last execution time 120 the enabled PLC model 114 executed an instruction, such as may be stored in the memory 104 or elsewhere, such as within the PLC model 114 itself. The third logic 106 may then be further executable by the processor 102 to cause the processor 102 to determine an amount of execution time necessary to execute the next instruction, such as based on the performance characteristics of the enabled PLC model 114. As was described above, the performance characteristics of each PLC model, reflective of the performance of the PLC modeled thereby, may vary for different instructions executed by the PLC as well as from PLC to PLC. Generally, the third logic 106 may be further executable by the processor 102 to cause the processor 102 to determine whether a difference between the current time and the last time 120 is at least greater than zero, the sufficiency of the available time being determined based thereon. More particularly, the third logic 106 may be further executable by the processor 102 to cause the processor 102 to determine if the difference between the current time and the last time 120 exceeds the amount of time required to execute the next instruction.

In one embodiment, the third logic 110 may be further executable by the processor 102 to cause the processor 102 update, subsequent to the execution of the next instruction, the last time the enabled PLC model 114 executed an instruction 120 to equal the last time the enabled PLC model 110 executed an instruction 120 plus the associated execution time. Further, in one embodiment, the third logic 110 may be further executable by the processor 102 to cause the processor 102 to update the current time to equal the last time the enabled PLC model 114 executed an instruction 120.

In one embodiment, the third logic 110 may be further executable by the processor 102 to cause the processor 102 to allow the enabled PLC model 114 to execute the next instruction when sufficient time is not available to execute the next instruction prior to the disabling and none of the other PLC models 114 have executed an instruction when last enabled.

While the system 100 was described with respect to the functionality of the first, second and third logic 106, 108, 110 to control operation of the simulated PLCs, it will be appreciated that the described functionality, or a portion thereof, may be implemented instead as part of each PLC model.

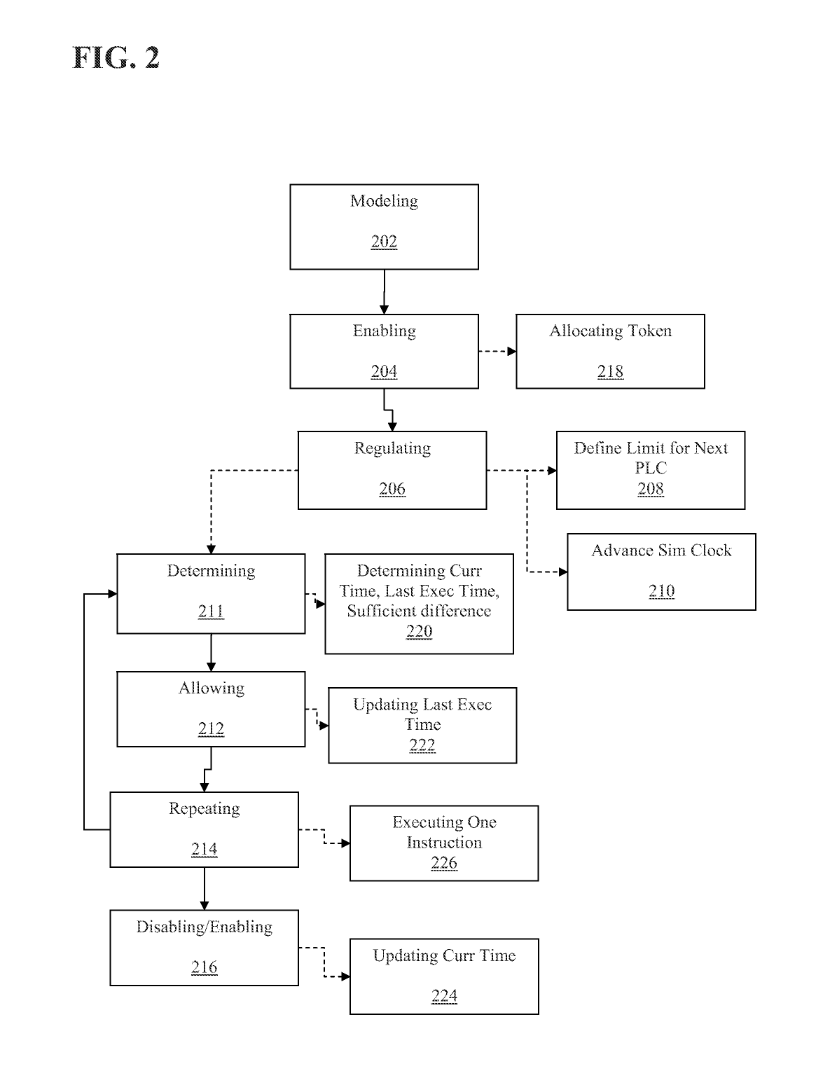

FIG. 2 depicts a flow chart showing operation of the system 100 of FIG. 1 for simulating a plurality of PLCs, each of the PLCs being characterized by at least one performance characteristic, such as the control program instruction execution performance thereby which may vary among instructions as well as among the PLCs. In particular, the operation includes: modeling, by a processor 102, operation of each of the plurality of PLCs (Block 202); enabling, by the processor 102, each PLC model 114 to simulate operation of the associated modeled PLC, the remaining PLC models 114 not being enabled to simulate operation of the associated modeled PLC (Block 204); and regulating, by the processor 102, initiation of instruction execution by the enabled PLC model 114, based on the at least one performance characteristic of the PLC modeled thereby, relative to an instruction execution performance of one or more of the previously enabled PLC models 114 (Block 206).

In one embodiment, the instruction execution performance of one or more of the previously enabled PLC models 114 comprises a longest cumulative execution time of any of the one or more previously enabled PLC models 114 needed to complete execution of instructions initiated when the particular of the one or more previously enabled PLC models 114 was previously enabled.

In one embodiment, the operation of the system 100 further includes defining the instruction execution performance for the next PLC model 114 to be enabled based on completion of execution of the instruction for which execution was initiated by the enabled PLC model 114 (Block 208).

In one embodiment, the operation of the system 100 further includes advancing, by the processor 102, a simulated clock 116 value based on a cumulative time to complete execution of the instructions initiated by the enabled PLC model 114, the instruction execution performance for the next enabled PLC model 114 being defined thereby (Block 210).

In one embodiment, the operation of the system 100 further includes: determining, by the processor 102, if sufficient time is available to initiate execution of a next instruction of a plurality of instructions since the enabled PLC model 114 last executed an instruction 120 (Block 211) and, if sufficient time is available, allow the enabled PLC model 114 to at least initiate execution of the next instruction (Block 212); repeating, by the processor 102, the determining until sufficient time is not available to initiate execution of a next instruction of a remainder of the plurality of instructions (Block 214); and wherein when sufficient time is not available, disabling, by the processor 102, the enabled PLC model 114 to simulate operation and enabling another of the plurality of PLC models 114 to simulate operation (Block 216).

In one embodiment, the enabling may further include allocating, by the processor 102, a token 122 to one of the plurality of PLC models 114, the token 122 being operative to enable the one PLC model 114 to execute instructions (Block 218).

In one embodiment, the determining may further include determining, by the processor 102, a current time and a last execution time the enabled PLC model 114 executed an instruction 120, and determining, by the processor 102, whether a difference between the current time and the last time 120 is at least greater than zero, the sufficiency of the available time being determined based thereon (Block 220). The determining may further include determining an amount of execution time necessary to execute the next instruction. In one embodiment, the associated execution time is based on the at least one performance characteristic of the PLC modeled by the enabled PLC model 114 and may vary among instructions as well as among PLCs.

In one embodiment, the allowing may further include updating, subsequent to the execution of the next instruction, the last time the enabled PLC model 114 executed an instruction 120 to equal the last time the enabled PLC model 114 executed an instruction 120 plus the associated execution time (Block 222).

In one embodiment, the disabling may further include updating the current time to equal the last time the enabled PLC model 114 executed an instruction 120 (Block 224).

In one embodiment, the repeating may further include allowing, by the processor 102, the enabled PLC model 114 to execute the next instruction when sufficient time is not available to execute the next instruction prior to the disabling and none of the other PLC models 114 executed an instruction when last enabled (Block 226).

In one embodiment, the enabling may further include allocating, by the processor 102, a token 122 to one of the plurality of PLC models 114, the token 122 being operative to enable the one PLC model 114 to execute instructions, the token 122 further including data representative of the current time (Block 218).

In one embodiment, the current time may be obtained by the processor 102 from a server coupled with the processor 102.

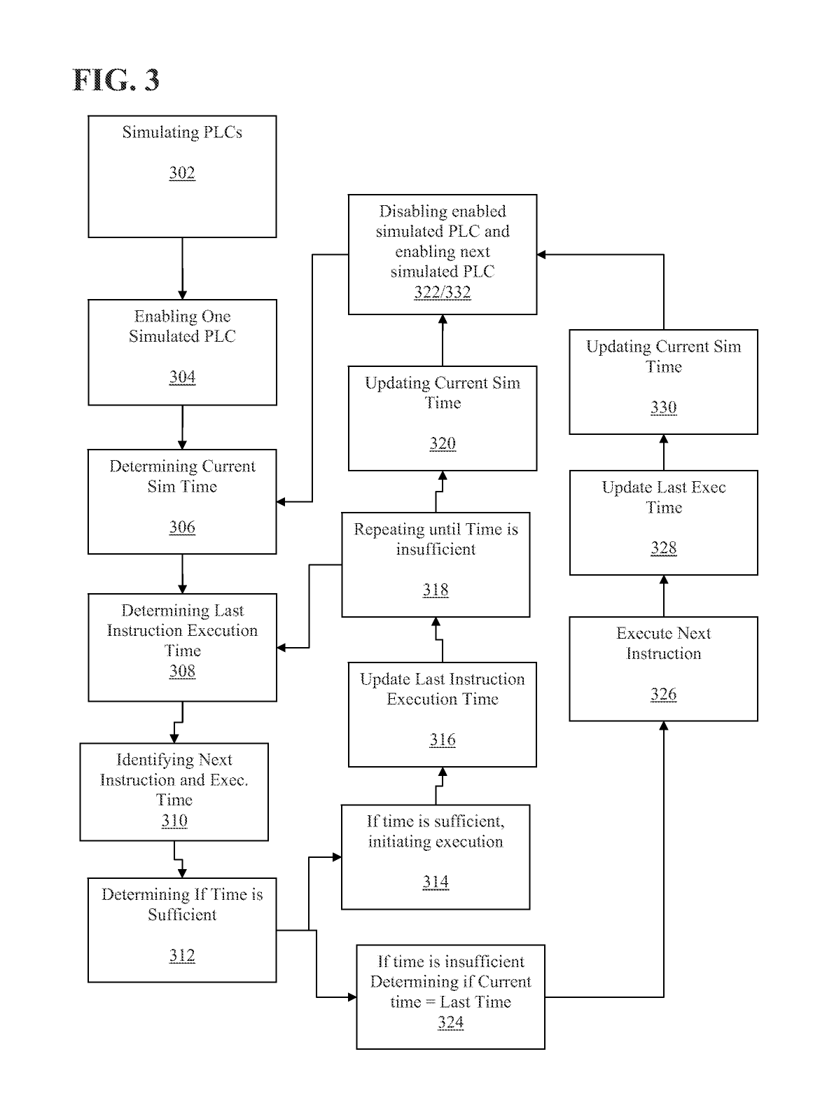

FIG. 3 depicts a flow chart showing exemplary operation of the system 100 of FIG. 1 for simulating a plurality of PLCs, each of the PLCs being characterized by at least one performance characteristic, such as the control program instruction execution performance thereby which may vary among instructions as well as among the PLCs. In particular, the operation includes: simulating, by a processor 102, operation of each of the plurality of PLCs (Block 302); enabling, by a processor 102, one of the plurality of simulated PLCs 114 to operate (Block 304); determining, by the processor 102, the current simulation time (Block 306); determining, by the processor 102, a last time the enabled simulated PLC 114 executed an instruction 120 (Block 308); identifying, by the processor 102, a next instruction to be executed and an associated execution time thereof, the associated execution time being based on the at least one performance characteristic of the PLC being simulated by the enabled simulated PLC 114 (Block 310); determining, by the processor 102, whether the last time the enabled simulated PLC 114 executed an instruction 120 plus the associated execution time is less than the current simulation time and if the last time the enabled simulated PLC 114 executed an instruction 120 is less than the current simulation time (Block 312), causing, by the processor 102, the enabled simulated PLC 114 to at least initiate execution the next instruction (Block 314) and update the last time the enabled simulated PLC 114 executed an instruction 120 to include the associated execution time (Block 316), repeating, by the processor 102, the identifying and determining of the last time the enabled simulated PLC 114 executed an instruction 120 based on the updated last time the enabled simulated PLC 114 executed an instruction 120 until the updated last time the enabled simulated PLC 114 executed an instruction 120 is not less than the current simulation time (Block 318), subsequently updating the current simulation time to equal the updated last time the enabled simulated PLC 114 executed an instruction 120 (Block 320), and disabling, by the processor 102, the enabled simulated PLC 114, and enabling, by the processor 102, another of the plurality of simulated PLCs 114 to operate (Block 322); and determining, by the processor 102, whether the current simulation time is equal to the last time the enabled simulated PLC 114 executed an instruction 120 and if the current simulation time is equal to the last time the enabled simulated PLC 114 executed an instruction 120 (Block 324) causing, by the processor 102, the enabled simulated PLC 114 to at least initiate execution the next instruction (Block 326) and update the last time the enabled simulated PLC 114 executed an instruction 120 to include the associated execution time (Block 328) and subsequently updating the current simulation time to equal the updated last time the enabled simulated PLC 114 executed an instruction 120 (Block 330), and disabling, by the processor 102, the enabled simulated PLC 114, and enabling, by the processor 102, another of the plurality of simulated PLCs 114 to operate (Block 332).

The following pseudo code depicts an exemplary implementation of the disclosed embodiments described above:
t_{current}: current virtual time (provided by the token passed or from a time server when token received by PLC)
tₗₐₛₜ: virtual time when an instruction was lasted executed by a given PLC (each PLC keeps up with its own value)
t_{instruction}: time required to execute the next queued instruction on given instruction on a given PLC.

A PLC receives the token.

```
if (t_{current} > (t_{last +} t_{instruction})
{
  repeat
  {
    execute a queued instruction
    tₗₐₛₜ = tₗₐₛₜ + t_{instruction}
    t_{instruction} = t_{instruction} of next queued instruction
  }
  until (tₗₐₛₜ >= t_{current})
  t_{current} = tₗₐₛₜ
  pass the token
}
else if (t_{current} = tₗₐₛₜ ))
{
```

execute one queued instruction (this is where the algorithm ensures that at least one instruction is executed on at least one PLC per cycle)

```
  t_{current} = tₗₐₛₜ = tₗₐₛₜ + t_{instruction}
  t_{instruction} = t_{instruction} of next queued instruction
  pass the token
}
else
{
  pass the token (this is case where the controller will only pass the token
and not execute an instruction)
}
```

The following table (Table 1) demonstrates operation of the disclosed embodiments according to the exemplary pseudo code provided above. In the exemplary operation:
The order in which the time token is passed is PLC1->PLC2->PLC3
PLC1 to execute program loop:
A(1)₁; A(1)₂; B(2)₃; B(2)₄; B(2)₅; B(2)₆; A(1)₇; A(1)₈; B(2)₉; B(2)₁₀; B(2)₁₁; B(2)₁₂; A(1)₁₃
PLC2 to execute program loop: A(3)₁; B(4)₂; A(3)₃; B(4)₄; A(3)₅
PLC3 to execute program loop: B(4)₁; A(3)₂; B(4)₃; A(3)₄; B(4)₅
Where the number in parentheses is the execution time (number of ticks) of the instruction on the particular PLC. The subscript distinguishes the instructions.
Exe?=does the PLC execute the next instruction (Inext)
A cycle defined as the token having been passed to each PLC in turn

TABLE 1

| | | PLC 1 | | | | PLC 2 | | | | PLC 3 | | |
|---|---|---|---|---|---|---|---|---|---|---|---|---|
| Cycle | t_{cur} | tₗₐₛₜ | Iₙₑₓₜ | Exe? | t_{cur} | tₗₐₛₜ | Iₙₑₓₜ | Exe? | t_{cur} | tₗₐₛₜ | Iₙₑₓₜ | Exe? |
| 0 | 0 | 0 | A(1)₁ | Y | 1 | 0 | A(3)₁ | N | 1 | 0 | B(4)₁ | N |
| 1 | 1 | 1 | A(1)₂ | Y | 2 | 0 | A(3)₁ | N | 2 | 0 | B(4)₁ | N |
| 2 | 2 | 2 | B(2)₃ | Y | 4 | 0 | A(3)₁ | Y | — | — | — | — |
| — | — | — | — | — | 4 | 3 | B(4)₂ | Y | 7 | 0 | B(4)₁ | Y |
| — | — | — | — | — | — | — | — | — | 7 | 4 | A(3)₂ | Y |
| 3 | 7 | 4 | B(2)₄ | Y | — | — | — | — | — | — | — | — |
| — | 7 | 6 | B(2)₅ | Y | 8 | 7 | A(3)₃ | N | 8 | 7 | B(4)₃ | N |
| 4 | 8 | 8 | B(2)₆ | Y | 10 | 7 | A(3)₃ | N | 10 | 7 | B(4)₃ | N |
| 5 | 10 | 10 | A(1)₇ | Y | 11 | 7 | A(3)₃ | Y | — | — | — | — |
| — | — | — | — | — | 11 | 10 | B(4)₄ | Y | 14 | 7 | B(4)₃ | Y |
| — | — | — | — | — | — | — | — | — | 14 | 11 | A(3)₄ | Y |
| 6 | 14 | 11 | A(1)₈ | Y | — | — | — | — | — | — | — | — |
| — | 14 | 12 | B(2)₉ | Y | 14 | 14 | A(3)₅ | Y | 17 | 14 | B(4)₅ | N |
| 7 | 17 | 14 | B(2)₁₀ | Y | — | — | — | — | — | — | — | — |
| — | 17 | 16 | B(2)₁₁ | Y | 18 | 17 | A(3)₁ | N | 18 | 14 | B(4)₅ | N |
| 8 | 18 | 18 | B(2)₁₂ | Y | 20 | 17 | A(3)₁ | Y | 20 | 14 | B(4)₅ | Y |
| — | — | — | — | — | — | — | — | — | 20 | 18 | B(4)₁ | Y |
| 9 | 22 | 20 | A(1)₁₃ | Y | — | — | — | — | — | — | — | — |
| — | 22 | 21 | A(1)₁ | Y | 22 | 17 | B(4)₂ | Y | — | — | — | — |
| — | — | — | — | — | 22 | 21 | A(3)₃ | Y | 24 | 22 | A(3)₂ | N |
| 10 | 24 | 22 | A(1)₂ | Y | — | — | — | — | — | — | — | — |
| — | 24 | 23 | B(2)₃ | Y | 25 | 24 | B(4)₄ | N | 25 | 22 | A(3)₂ | N |
| 11 | 25 | 25 | B(2)₄ | Y | 27 | 24 | B(4)₄ | N | 27 | 22 | A(3)₂ | Y |
| — | — | — | — | — | — | — | — | — | 27 | 25 | B(4)₃ | Y |
| 12 | 29 | 25 | B(2)₅ | Y | — | — | — | — | — | — | — | — |
| — | 29 | 27 | B(2)₆ | Y | 29 | 24 | B(4)₄ | Y | — | — | — | — |
| — | — | — | — | — | 29 | 28 | A(3)₅ | Y | 31 | 28 | A(3)₄ | N |
| 13 | 31 | 29 | A(1)₇ | Y | — | — | — | — | — | — | — | — |
| — | 31 | 30 | A(1)_{S} | Y | 31 | 31 | A(3)₁ | Y | 34 | 28 | A(3)₄ | Y |
| — | — | — | — | — | — | — | — | — | 34 | 31 | B(4)₅ | Y |
| 14 | 35 | 31 | B(2)₉ | Y | — | — | — | — | — | — | — | — |
| — | 35 | 33 | B(2)₁₀ | Y | 35 | 34 | B(4)₂ | N | 35 | 35 | B(4)₁ | Y |
| 15 | 39 | 35 | B(2)₁₁ | Y | — | — | — | — | — | — | — | — |
| — | 39 | 37 | B(2)₁₂ | Y | 39 | 34 | B(4)₂ | Y | — | — | — | — |
| — | — | — | — | — | 39 | 38 | A(3)₃ | Y | 41 | 39 | A(3)₂ | N |
| 16 | 41 | 39 | A(1)₁₃ | Y | | | | | | | | |
| — | 41 | 40 | A(1)₁ | Y | 41 | 41 | B(4)₄ | Y | 45 | 39 | A(3)₂ | Y |
| — | — | — | — | — | — | — | — | — | 45 | 42 | A(3)₄ | Y |
| 17 | 45 | 41 | A(1)₂ | Y | — | — | — | — | — | — | — | — |
| — | 45 | 42 | B(2)₃ | Y | — | — | — | — | — | — | — | — |
| — | 45 | 44 | B(2)₄ | Y | 46 | 45 | A(3)₅ | N | 46 | 45 | B(4)₅ | N |
| 18 | 46 | 46 | B(2)₅ | Y | 48 | 45 | A(3)₅ | N | 48 | 45 | B(4)₅ | N |
| 19 | 48 | 48 | B(2)₆ | Y | 50 | 45 | A(3)₅ | Y | — | — | — | — |
| — | — | — | — | — | 50 | 48 | A(3)₁ | Y | 51 | 45 | B(4)₅ | Y |
| — | — | — | — | — | — | — | — | — | 51 | 49 | B(4)₁ | Y |
| 20 | 53 | 50 | A(1)₇ | Y | — | — | — | — | — | — | — | — |
| — | 53 | 51 | A(1)₈ | Y | — | — | — | — | — | — | — | — |
| — | 53 | 52 | B(2)₉ | Y | 54 | 51 | B(4)₂ | N | 54 | 53 | A(3)₂ | N |
| 21 | 54 | 54 | B(2)₁₀ | Y | 56 | 51 | B(4)₂ | Y | — | — | — | — |
| — | — | — | — | — | 56 | 55 | A(3)₃ | Y | 58 | 53 | A(3)₂ | Y |
| — | — | — | — | — | — | — | — | — | 58 | 56 | B(4)₃ | Y |
| 22 | 60 | 56 | B(2)₁₁ | Y | — | — | — | — | — | — | — | — |
| — | 60 | 58 | B(2)₁₂ | Y | 60 | 58 | B(4)₄ | N | 60 | 60 | A(3)₄ | Y |
| 23 | 63 | 60 | A(1)₁₃ | Y | — | — | — | — | — | — | — | — |
| — | 63 | 61 | A(1)₁ | Y | — | — | — | — | — | — | — | — |
| — | 63 | 62 | A(1)₂ | Y | 63 | 58 | B(4)₄ | Y | — | — | — | — |
| — | — | — | — | — | 63 | 62 | A(3)₅ | Y | 65 | 63 | B(4)₅ | N |

As can be seen from the above table, PLC1 completes 3 iterations of its control program loop. PLC2 completes 4 iterations of its control program loop and PLC3 completes 3 iterations of its control program loop. Accordingly, a user wishing to physically implement the modeled PLCs can account for the depicted performance. If, for example, it was necessary for PLC2 to complete 4 iterations for ever 3 iterations completed by PLC1, necessary adjustments may be made.

One skilled in the art will appreciate that one or more components described herein may be implemented using, among other things, a tangible computer-readable medium comprising computer-executable instructions (e.g., executable software code). Alternatively, modules may be implemented as software code, firmware code, hardware, and/or a combination of the aforementioned. For example the modules may be embodied as part of a programmable logic controller as described above.

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above, such as the PLC 100 or a component thereof, may be a computer system 400 or a component in the computer system 400. The computer system 400 may implement a programmable logic controller, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include a disk or optical drive unit 406. The disk drive unit 406 may include a computer-readable medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a Modbus network, cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

What is claimed is:

1. A computer implemented method of simulating operation of a plurality of programmable logic controllers (“PLC”), each of the plurality of PLCs being characterized by at least one performance characteristic, the method comprising:
modeling, by a processor 102, operation of each of the plurality of PLCs (Block 202);
enabling, by the processor 102, each PLC model 114 to simulate operation of the associated modeled PLC, the remaining PLC models 114 not being enabled to simulate operation of the associated modeled PLC (Block 204); and
regulating, by the processor 102, initiation of instruction execution by the enabled PLC model 114, based on the at least one performance characteristic of the PLC modeled thereby, relative to an instruction execution performance of one or more of the previously enabled PLC models 114 (Block 206).

2. The computer implemented method of claim 1 wherein the at least one performance characteristic of each of the plurality of PLCs characterizes a performance of instruction execution thereby.

3. The computer implemented method of claim 1 wherein the instruction execution performance of one or more of the previously enabled PLC models 114 comprises a longest cumulative execution time of any of the one or more previously enabled PLC models 114 needed to complete execution of instructions initiated when the particular of the one or more previously enabled PLC models 114 was previously enabled.

4. The computer implemented method of claim 1 further comprising:
advancing, by the processor 102, a simulated clock 116 value based on a cumulative time to complete execution of the instructions initiated by the enabled PLC model 114, the instruction execution performance for the next enabled PLC model 114 being defined thereby (Block 210).

5. The computer implemented method of claim 1 wherein the regulating further comprises:
determining, by the processor 102, if sufficient time is available to initiate execution of a next instruction of a plurality of instructions since the enabled PLC model 114 last executed an instruction 120 (block 211) and, if sufficient time is available, allowing the enabled PLC model 114 to at least initiate execution of the next instruction (Block 212);
repeating, by the processor 102, the determining until sufficient time is not available to initiate execution of a next instruction of a remainder of the plurality of instructions (Block 214); and
wherein when sufficient time is not available, disabling, by the processor 102, the enabled PLC model 114 to simulate operation and enabling another of the plurality of PLC models 114 to simulate operation (Block 216).

6. The computer implemented method of claim 5 wherein the determining further comprises determining, by the processor 102, a current time and a last execution time the enabled PLC model 114 executed an instruction 120, and determining, by the processor 102, whether a difference between the current time and the last time 120 is at least greater than zero, the sufficiency of the available time being determined based thereon (Block 220).

7. The computer implemented method of claim 6 wherein the allowing further comprises updating, subsequent to the execution of the next instruction, the last time the enabled PLC model 114 executed an instruction 120 to equal the last time the enabled PLC model 114 executed an instruction 120 plus the associated execution time (Block 222).

8. The computer implemented method of claim 7 wherein the disabling further comprises updating the current time to equal the last time the enabled PLC model 114 executed an instruction 120 (Block 224).

9. The computer implemented method of claim 6 wherein the repeating further comprises allowing, by the processor 102, the enabled PLC model 114 to execute the next instruction when sufficient time is not available to execute the next instruction prior to the disabling and none of the other PLC models 114 executed an instruction when last enabled (Block 226).

10. The computer implemented method of claim 6 wherein the amount of execution time to execute the next instruction is different from an amount of execution time to execute another instruction.

11. A system 100 for simulating operation of a plurality of programmable logic controllers (“PLC”), each of the plurality of PLCs being characterized by at least one performance characteristic, the system 100 comprising:
first logic 106 stored in a memory 104 and executable by a processor 102 to cause the processor 102 to model operation of each of the plurality of PLCs;
second logic 108 stored in the memory 104 and executable by the processor 102 to cause the processor 102 to enable each PLC model 114 to simulate operation of the associated modeled PLC, the remaining PLC models 114 not being enabled to simulate operation of the associated modeled PLC; and
third logic 110 stored in the memory 104 and executable by the processor 102 to cause the processor 102 to regulate initiation of instruction execution by the enabled PLC model 114, based on the at least one performance characteristic of the PLC modeled thereby, relative to an instruction execution performance of one or more of the previously enabled PLC models 114.

12. The system 100 of claim 11 wherein the instruction execution performance of one or more of the previously enabled PLC models 114 comprises a longest cumulative execution time of any of the one or more previously enabled PLC models 114 needed to complete execution of instructions initiated when the particular of the one or more previously enabled PLC models 114 was previously enabled.

13. The system 100 of claim 11 wherein the third logic 110 is further executable by the processor 102 to cause the processor 102 to advance a simulated clock 116 value based on a cumulative time to complete execution of the instructions initiated by the enabled PLC model 114, the instruction execution performance for the next enabled PLC model 114 being defined thereby.

14. The system 100 of claim 11 wherein the third logic 110 is further executable by the processor 102 to cause the processor 102 to determine if sufficient time is available to initiate execution of a next instruction of a plurality of instructions since the enabled PLC model 114 last executed an instruction 120 and, if sufficient time is available, allow the enabled PLC model 114 to at least initiate execution of the next instruction, repeat the determining until sufficient time is not available to initiate execution of a next instruction of a remainder of the plurality of instructions, and, wherein when sufficient time is not available, disable the enabled PLC model 114 to simulate operation and enabling another of the plurality of PLC models 114 to simulate operation.

15. The system 100 of claim 14 wherein the third logic is further executable by the processor 102 to cause the processor 102 to allocate a token 122 to one of the plurality of PLC models 114, the token 122 being operative to enable the one PLC model 114 to execute instructions.

16. The system of claim 14 wherein the third logic 110 is further executable by the processor 102 to cause the processor 102 to determine a current time and a last execution time 120 the enabled PLC model 114 executed an instruction, and further determine whether a difference between the current time and the last time is at least greater than zero, the sufficiency of the available time being determined based thereon.

17. The system of claim 16 wherein the third logic 110 is further executable by the processor 102 to cause the processor 102 update, subsequent to the execution of the next instruction, the last time the enabled PLC model 114 executed an instruction 120 to equal the last time the enabled PLC model 110 executed an instruction 120 plus the associated execution time.

18. The system of claim 17 wherein the third logic 110 is further executable by the processor 102 to cause the processor 102 to update the current time to equal the last time the enabled PLC model 114 executed an instruction 120.

19. The system of claim 16 wherein the third logic 110 is further executable by the processor 102 to cause the processor 102 to allow the enabled PLC model 114 to execute the next instruction when sufficient time is not available to execute the next instruction prior to the disabling and none of the other PLC models 114 have executed an instruction when last enabled.

20. A computer implemented method for simulating a plurality of programmable logic controllers (“PLC”), each of the plurality of PLCs being characterized by at least one performance characteristic, the method comprising:
simulating, by a processor 102, operation of each of the plurality of PLCs (Block 302);
enabling, by a processor 102, one of the plurality of simulated PLCs 114 to operate (Block 304);
determining, by the processor 102, the current simulation time (Block 306);
determining, by the processor 102, a last time the enabled simulated PLC 114 executed an instruction 120 (Block 308);
identifying, by the processor 102, a next instruction to be executed and an associated execution time thereof, the associated execution time being based on the at least one performance characteristic of the PLC being simulated by the enabled simulated PLC 114 (Block 310);
determining, by the processor 102, whether the last time the enabled simulated PLC 114 executed an instruction 120 plus the associated execution time is less than the current simulation time and if the last time the enabled simulated PLC 114 executed an instruction 120 is less than the current simulation time (Block 312), causing, by the processor 102, the enabled simulated PLC 114 to at least initiate execution the next instruction (Block 314) and update the last time the enabled simulated PLC 114 executed an instruction 120 to include the associated execution time (Block 316), repeating, by the processor 102, the identifying and determining of the last time the enabled simulated PLC 114 executed an instruction 120 based on the updated last time the enabled simulated PLC 114 executed an instruction until the updated last time the enabled simulated PLC 114 executed an instruction 120 is not less than the current simulation time (Block 318), subsequently updating the current simulation time to equal the updated last time the enabled simulated PLC 114 executed an instruction (Block 320), and disabling, by the processor 102, the enabled simulated PLC 114, and enabling, by the processor 102, another of the plurality of simulated PLCs 114 to operate (Block 322); and
determining, by the processor 102, whether the current simulation time is equal to the last time the enabled simulated PLC 114 executed an instruction 120 and if the current simulation time is equal to the last time the enabled simulated PLC 114 executed an instruction 120 (Block 324) causing, by the processor 102, the enabled simulated PLC 114 to at least initiate execution the next instruction (Block 326) and update the last time the enabled simulated PLC 114 executed an instruction to include the associated execution time (Block 328) and subsequently updating the current simulation time to equal the updated last time the enabled simulated PLC 114 executed an instruction 120 (Block 330), and disabling, by the processor 102, the enabled simulated PLC 114, and enabling, by the processor 102, another of the plurality of simulated PLCs 114 to operate (Block 332).
